(19) United States
(12) Patent Application Publication
(10) Pub. No.: US 2026/0000022 A1
(43) Pub. Date: Jan. 1, 2026

(54) SENSOR ARRANGEMENT FOR DETECTING GRAINS IN A MATERIAL STREAM CONTAINING GRAINS AND NON-GRAIN COMPONENTS IN A COMBINE HARVESTER

(71) Applicant: Deere & Company, Moline, IL (US)

(72) Inventors: Marco Broschart, HERSCHBERG (DE); Thomas Fell, Schriesheim (DE); Martin Rittershofer, Zweibrücken (DE); Eric L. Bortner, Davenport, IA (US); Matthew T. Wold, Coal Valley, IL (US)

(21) Appl. No.: 19/247,324

(22) Filed: Jun. 24, 2025

(30) Foreign Application Priority Data
Jun. 27, 2024 (DE) 102024118178.8

(51) Int. Cl. A01D 41/127; G01N 1/20; G01N 1/40; G06V 20/59

(52) U.S. Cl. CPC A01D 41/1273; G01N 1/20; G01N 1/4077; G06V 20/59

(57) ABSTRACT

A sensor arrangement for detecting grains in a material stream containing grains and non-grain components in a combine harvester may include a sampling device configured to collect a sample from the material stream; a separation device configured to separate the sample into grains and non-grain constituents; and a sensor system configured to sense the grains separated from the non-grain constituents.

### CROSS-REFERENCE TO RELATED APPLICATIONS

This application claims priority to German Patent Application No. 102024118178.8, filed Jun. 27, 2024, which is hereby incorporated by reference.

### FIELD OF THE DISCLOSURE

The present disclosure relates to a sensor arrangement for detecting grains in a material stream containing grains and non-grain components in a combine harvester.

### BACKGROUND

Combine harvesters are used to harvest grain. The above-ground parts of plants, such as soybeans, corn, wheat or oats, are cut off or collected or stripped, or the inflorescences of the plants, such as corn or sunflowers, are separated and fed to a threshing and separation device to separate the fruit (grain) from the remaining components of the crop. After the threshing and separation process, there are still impurities in the grain, such as straw particles and chaff. The mixture of grain and impurities obtained during threshing and separation is therefore fed into a cleaning system, which usually includes an upper and lower sieve and optionally a chaffer.

While the cleaned grain, after passing through the upper and lower sieves, is conveyed by an elevator into the grain tank, and the material discharged at the end of the lower sieve (tailings) is fed to a secondary threshing process. At the end of the upper sieve, remaining material is discharged onto the field, whether by a chaff spreader or a chopping and distribution device for the non-grain material discharged by the separation device. The non-grain material discharged by the separation device after the separation process is also usually discharged into the field, usually by the chopping and distribution device, or the non-grain material is deposited in a swath.

### SUMMARY OF THE DISCLOSURE

An example of the present disclosure is directed to sensor arrangement configured to detect grains in a material stream containing grains and non-grain components in a combine harvester. The sensor arrangement may include a sampling device configured to collect a sample from the material stream; a separation device configured to separate the sample into grains and non-grain constituents; and a sensor system configured to sense the grains separated from the non-grain constituents.

Another example of the present disclosure is directed to a combine harvester that may include a sensor arrangement. The sensor arrangement may include a sampling device configured to collect a sample from the material stream; a separation device configured to separate the sample into grains and non-grain constituents; and a sensor system configured to sense the grains separated from the non-grain constituents.

Another example of the present disclosure is directed to a method for sensing grains in a material stream containing grains and non-grain components in a combine harvester. The method may include collecting a sample from the material stream with a sampling device; separating, with a separation device, of the sample into grains and non-grain constituents by a separation device; and detecting, with a sensor system, the grains separated from the non-grain constituents.

The various examples may include one or more of the following features. The sampling device may be configured to collect the sample downstream of a rear end of an upper sieve; downstream of a rear end of a lower sieve; between a threshing device and a cleaning device; between a separation device and a cleaning device; downstream of a crop residue outlet of the threshing device; or downstream of a crop residue outlet of the separation device. The sampling device may be movable over a width of the material flow. The separation device may include a centrifugal separator, a cyclone separator, a sieving device, or a zig-zag classifier. The sensor system may include a camera with image processing configured to detect the grains or a force sensor configured to detect a weight of the grains separated from the non-grain constituents. The separation device may include a collection chamber configured to collect grains separated from the non-grain constituents and a dispensing mechanism configured to feed the grains from the collection chamber to the sensor system. A control device may be configured to control one or more operating parameters of a combine harvester based on one or more signals of the sensor system. The control device may be connected to one or more impact plate sensors configured to detect lost grains and configured to fuse the signals of the one or more impact plate sensors with the signals of the sensor assembly.

### BRIEF DESCRIPTION OF THE DRAWINGS

The drawings show examples described in more detail below. The drawings show:

FIG. 1 is a schematic side view of an example combine harvester.

FIG. 2 is a schematic plan view of an example combine harvester cleaning sieve with a sensor arrangement.

FIG. 3 is a schematic side view of the example cleaning sieve and sensor arrangement of FIG. 2.

FIG. 4 is a schematic side view of another example sensor arrangement disposed adjacent to a cleaning sieve.

FIG. 5 is schematic side view of another example sensor arrangement disposed adjacent to a cleaning sieve.

### DETAILED DESCRIPTION

Generally, some amount of grain is present in the stream of crop residue exiting an upper sieve and the stream of crop residue released from a distribution device that are released into the field. To optimise the setting of the combine's operating parameters, it is useful to sense the number of grain losses delivered to the field via these residue streams. Other locations for sensors for detecting a grain flow in a combine harvester can be found between the threshing and/or separation device and the cleaning system (cf. DE 40 35 471 A1 and DE 10 2013 24 984 A1) and in the tailings (EP 1 516 522 A2).

The number of grains in a material stream in combine harvesters is usually detected by impact plate sensors, which detect mechanical vibrations caused by the impact of grains (see, for example, DE 1 810 519 A) or changes in the electrical properties of a sensitive layer resulting from the impact of grains (EP 2 977 735 A2).

In order to detect lost grains, it was also proposed to guide the harvest residue stream delivered by the combine harvester past a camera and to recognize the lost grains using image processing (US 2021/0088691 A1, WO 2024/036401 A1). Other sensors in combine harvesters are used to sense the properties of material streams containing grains that have already been cleaned, such as broken grain fractions (see DE 10 2010 062 417 A1).

In the case of impact plate sensors, it has proven problematic to capture absolute values for grain numbers with sufficient accuracy, as the signals emitted depend on a number of parameters that are usually unknown, such as throughput and characteristics of the crop, such as moisture, density, and dimensions of the grains. Therefore, these loss sensors are calibrated from time to time in a time-consuming manner, usually by counting the grains ejected into the field (see EP 2 764 764 A1 and EP 2 742 791 A2), or by a separate arrangement for collecting, cleaning, and weighing the crop residues deposited by the combine on the field (DE 40 09 981 A1).

When sensing the lost grains by cameras, it is also not easy to visually distinguish them from the non-grain material in which they are contained. The non-grain material includes, for example, straw particles, husks, and awns, and the non-grain material can have the same colour and partially similar shapes as the grains.

The task of the present disclosure is to propose an improved sensor arrangement and a corresponding method for detecting grains in a material stream containing grains and non-grain components in a combine harvester, which reduces or avoids problems associated with detecting grain in the streams of crop residue expelled during harvesting.

In some implementations, a sensor arrangement for detecting grains in a material stream containing grains and non-grain components in a combine harvester includes: a sampling device for taking a sample from the material stream; a separation device for separating the sample into grains and non-grain components; and a sensor system for sensing the grains.

Thus, there is no attempt to detect the individual grains within the material stream, which consists of grains (a plurality of grains are also referred to as grain in the context of the present disclosure) and non-grain constituents, by a sensor. Rather, in the present disclosure, the grains are separated from the material stream by a separation device. The grains separated by the separation device are fed to the sensor system and sensed by the latter. This improves the accuracy of the measurement and avoids the problems mentioned earlier or reduces those risks that may affect accuracy.

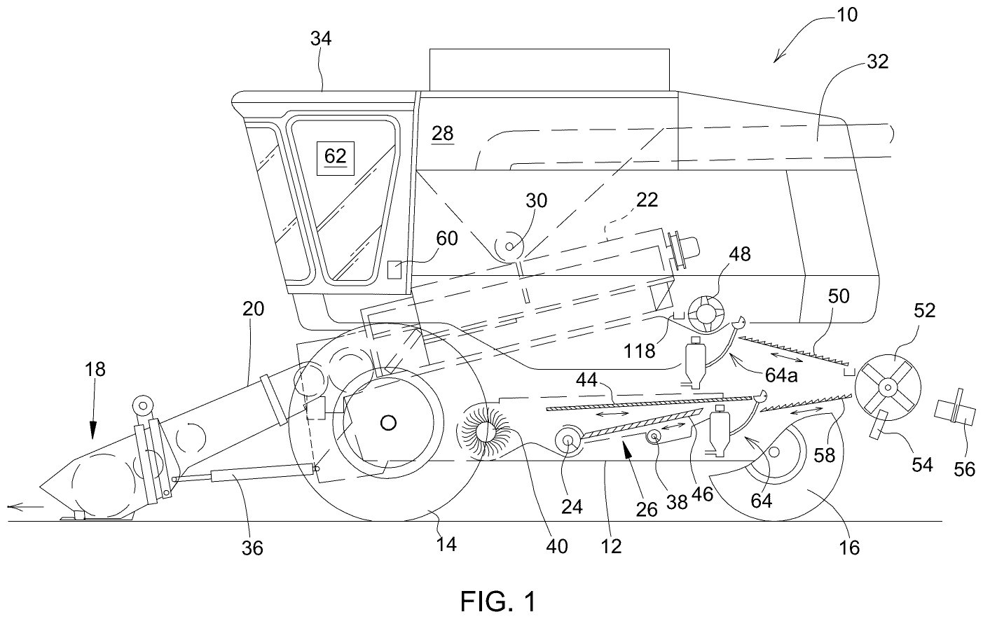

FIG. 1 shows a self-propelled harvester in the form of a combine harvester 10 with a chassis 12, which is supported on the ground by driven front wheels 14 and steerable rear wheels 16 and moved by them. Wheels 14 and 16 are set in rotation by a drive, not shown, in order to move the combine harvester 10, for example, over a field to be harvested. In the following, directional indications, such as front and rear, refer to the direction of travel V of the combine harvester 10 in harvesting operation, which runs to the left in FIG. 1.

A harvesting attachment 18 in the form of a platform is detachably connected to the front end of the combine harvester 10 in order to harvest crops in the form of grain or other threshable stalk crops from the field during harvesting operations and to feed the harvested crops upwards and backwards to an axial threshing and separation device 22 by a feederhouse assembly 20. The mixture containing grains and impurities that passes through the threshing concaves and grates in the axial threshing and separation device 22 enters a cleaning device 26. Grain cleaned by the cleaning device 26 is fed by a grain auger 24 to a grain elevator (not shown), which transports the cleaned grain to a grain tank 28. The cleaned grain from grain tank 28 can be unloaded through a discharging system with a transverse auger 30 and an unloading conveyor 32. These systems are driven by an internal combustion engine and are controlled by an operator from a driver's cab 34.

The cleaning device 26 includes an upper sieve 44 and a lower sieve 46, which are pressurised by a blower 40 with an air flow flowing through the sieves 44, 46 to the rear and above. The size of the sieve openings (angle of rotation of the slats of the sieves 44, 46) and the speed of the blower 40 can be changed automatically by a driver assistance system with an electronic control device 60 and associated actuators.

At the rear end of the axial threshing and separation device 22, a material stream that includes of straw and some (loss) grains that have not been removed from the harvested material in the axial threshing and separating device 22 is discharged to the rear and conveyed by a conveyor drum 48. This material flow passes through a conveyor floor 50 (or in free flight or by another conveyor, not shown) into a straw chopper 54, which chops the material in conjunction with counter-blades 54 and feeds the chopped material to a throwing distributor 56, which distributes the chopped material in the field. In some instances, although not illustrated, there is still a possibility to pass the said material past the straw chopper 54 and deposit the material in a swath on the field.

Material passing over the rear end of the lower sieve 46 falls downwards and is collected by a tailings auger and fed to a separate re-threshing device or to the axial threshing and separation device 22 as tailings. Grains removed from the tailings material flow are returned to the inlet of cleaning device 26.

Material passing over the rear end of the upper sieve 44, which includes mainly of chaff and some (loss) grains, is fed to the straw chopper 52 by a conveyor floor 58. The straw chopper 52 chops this material together with the material flow from the axial threshing and separating device 22 and feeds the combined material to the throwing distributor 56.

The combine harvester 10 shown is only an embodiment and can be varied as desired. For example, the axial threshing and separating device 22 could be replaced by a tangential threshing unit with one or more threshing and, if desired, separating drums and a subsequent separator in the form of a straw walker or one or more separating rotor(s). In some instances, downstream of the straw chopper 52, instead of the active throwing distributor 56, a passive distributor with a number of vanes arranged next to each other could be used, and the distribution of the chaff downstream of the upper sieve 44 could be carried out by chaff spreaders.

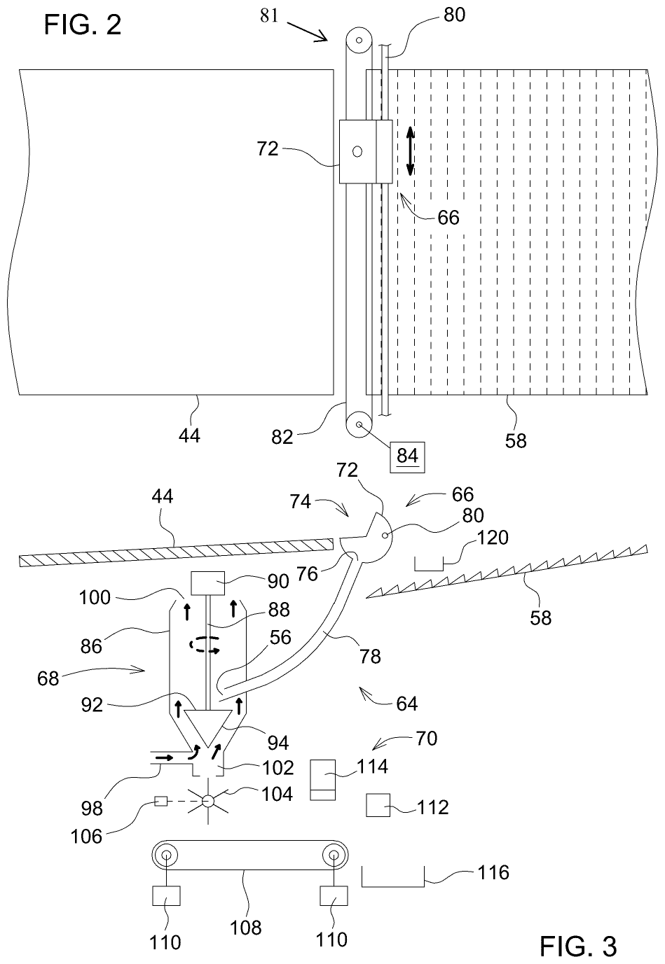

As already mentioned, the material discharged from the upper sieve 44 to the rear contains not only the chaff but also a certain proportion of lost grains, which do not end up in the grain tank 28, but in the field. The same applies to the material discharged from the axial threshing and separating device 22 into the straw chopper 52. In order to be able to automatically adjust the operating parameters of the combine harvester 10, such as the propelling speed and, thus, the throughput of crop through the combine harvester 10, as well as the opening size of the upper sieve 44 and/or the lower sieve 46 and the speed of the blower 40, by an electronic control device 60 and/or to be able to inform an operator in the cab 34 or at a spaced location of the respective losses by an operator interface 62, it is useful to measure the amount of grains lost. For this purpose, a sensor arrangement 64 is provided, which is shown in more detail in FIGS. 2 and 3. As shown in FIG. 1, such a sensor arrangement 64 is located at the rear outlet of the upper sieve 44 to detect the loss grains at the discharge end of the upper sieve 44, and a sensor arrangement 64a is located downstream of the outlet of the axial threshing and separating device 22 (e.g., at the rear of the conveyor drum 48). Such sensor assemblies 64 could also sense the material flow downstream of the rear end of the lower sieve 46 (tailings) and/or the material flow between the threshing section of the axial threshing and separating device 22 and the cleaning device 26 and/or the material flow between the separating section of the axial threshing and separating device 22 and the cleaning device 26 and/or downstream of the outlet of the straw chopper 52 and/or the throw distributor 56 and/or a chaff spreader in order to sense the grain flows there.

Reference is now made to FIGS. 2 and 3, in which the sensor arrangement 64 is shown. The sensor arrangement 64 configured for the detection of grains in a material stream containing grains and non-grain components. In this example, the sensor arrangement 64 is arranged at the discharge end of the upper sieve 44. The sensor arrangement 64 includes a sampling device 66 for taking a sample from the material flow, a separation device 68 for separating the sample into grains and non-grain components, and a sensor system 70 for sensing the grains.

The sampling device 66 is used to collect a certain proportion of the material flow released by the upper sieve 44 as a sample to be sensed. In the embodiment shown, the sampling device 66 includes a tub-shaped or trough-shaped housing 72 that defines an inlet opening 74 located approximately at the level of the top of the upper sieve 44. The rear wall of housing 72 with regard to the material flow is pulled upwards, so that the two side walls of housing 72 enclose a circular arc over an angle of approx. 225°. An outlet opening 76 is provided at the lower bottom of the housing 72, to which a line 78 is connected, through which the sample taken from the material flow by the inlet opening 74 enters the separation device 68. The tub-shaped or trough-shaped housing 72 of the sampling device 66 may be funnel-shaped in the lateral direction, analogous to the embodiment according to FIGS. 7 and 9a of WO 2024/036401 A1, the entirety of which is incorporated herein by reference.

The sampling device 66 in the embodiment shown can be moved laterally across the width of the upper sieve 44 (or at least part of the width of the upper sieve 44), which makes it possible to sense the lateral distribution of the loss grains. For this purpose, the line 78 is flexible and the housing 72 is supported on a transversely extending guide rod 80. A mechanism 81 with a cable 82 and a drive 84 is used to move the sampling device 66 in the lateral direction.

Accordingly, the sample enters the separation device 68 through line 78, by the effect of gravity and/or the air flow of the blower 40 above the upper sieve 44 and/or by a suction effect of an air flow present in the separation device 68. Separation device 68 is equipped to separate grains contained in the sample from the rest of the material (e.g., chaff and straw particles). In the embodiment shown, separation device 68 is designed as a centrifugal separator or a cyclone separator. The separation device 68 includes a shroud 86 in which a vertically oriented shaft 88 is set in rotation by a drive 90. A centrifugal disc 92 is arranged at the upper end of a cone 94 and is connected to the shaft 88 in a torque proof manner. The sample passes through an outlet 96 of line 78 to the centrifugal disc 92. The shroud 86 is supplied with the air flow from below through an air inlet 98, as indicated by the arrows. The sample is set in rotation by the centrifugal disc 92 and the centrifugal force causes the sample to reach the outside. The lighter (less mass-dense) components, i.e. the chaff, are carried upwards by the air flow and reach the outside through an upper opening 100, while the heavier components of the sample (grains) are transported downwards by gravity into a collection chamber 102. A dispensing mechanism 104 designed as a rotary valve can be set in rotation by a drive 106 in order to transfer the collected grains to the sensor system 70 as required.

Sensor system 70 is used to detect the grains that have been separated from the sample by separation device 68. In the embodiment shown, the sensor system 70 includes a conveyor belt 108, which can be set in rotation by a drive 112, and whose weight force (or mass) is detected by force sensors 110. A camera 114 with image processing software captures the grains on conveyor belt 108, and the grains are conveyed through conveyor belt 108 into a collection container 116. The contents of collection container 116 could be transferred to grain tank 28 by an assigned conveyor or (if collection tank 116 is sufficiently large) emptied by the operator of combine harvester 10, e.g., onto a transport vehicle, or the collection container 116 could be automatically packed into containers for further examination (e.g., in particular chemical or biological laboratory) (see DE 10 2010 062 417 A1). Alternatively, the grains could be released into the field, especially, for example, after the grains have been crushed by a suitable device so that the grains do not germinate in the field as new seeds.

Control device 60 is connected to and controls drives 84, 90, 106 and 112. In addition, control device 60 is connected to force sensors 110 and camera 114. Control device 60 does not necessarily have to be designed as a single unit, as shown in the figures, but can be composed of several components distributed over the combine 10. In addition, the control device 60 is connected to standard impact plate sensors 118, 120, which detect impacting loss grains downstream of the separation section of the axial threshing and separating device 22 or downstream of the upper sieve 44 in a well-known manner. For example, electronic signals are generated by the impact plate sensor 118, 120 when grains hit.

The function of the sensor arrangement 64 is as follows. The control device 60 automatically moves the sampling device 66 (or according to an instruction of the operator via the operator interface 62) by the drive 84 to a desired position along the width of the upper sieve 44. For example, a periodic reciprocating movement of the sampling device 66 takes place, in which all positions along the width of the upper sieve 44 are approached one after the other. In other instances, the sampling device 66 is moved selectively to those points along the width of the sieve 44 where an impact plate sensor 118 or 120 is located. After a new position has been approached by the sampling device 66, the collection chamber 102 is first emptied by the drive 106 and the conveyor belt 108 is also emptied by the drive 112. As a result, the grains present on the conveyor belt 108 are discharged into the collection container 116. For a predetermined time, the sample is taken from the material stream downstream of the upper sieve 44, and the grains are separated in separation device 68 and collected in collection chamber 102. In this process or after reaching of a determined fill state in the collection chamber 102, the dispensing mechanism 104 is activated continuously or discontinuously and the grains are discharged onto conveyor belt 108, where the grains are weighed by force sensors 110, counted by camera 114, and placed in container 116. The control device 60 then causes the sampling device 66 to be moved to a new position. If sampling of a sample is not intended, sensor assembly 64 can be deactivated, for example by actually closing the inlet opening 74 by a flap (not shown) and/or by moving the sampling device 66 to the side of the upper sieve 44 in an inoperative position.

The separation device 68 is, hence, used to isolate the grains from the sample and to simplify detection of the grains by the sensor system 70, since the latter (at least approximately) interacts exclusively with the grains, no longer with the original material flow, which contains a certain proportion of non-grain components (chaff and straw particles) in addition to the grains. According to this, the losses can be recorded with higher accuracy than before. In addition, regular calibration of sensor arrangement 64 by manual or automated counting of the grains ejected onto the field is unnecessary.

In this example, the sensor arrangement 64 is operated discontinuously, and the losses measured by the sensor arrangement 64 can be used to calibrate the impact plate sensors 118, 120 that are generally operated continuously for the detection of the losses in real time. Calibration is accomplished by continuously fusing the output values of the impact plate sensors 118, 120 at time intervals of, e.g., a few minutes, with measurements of the sensor arrangement 64. In this manner, the output of the impact plate sensors 118, 120 is converted into absolute values and, thus, calibrated. The losses calibrated in this manner may be used by control device 60 in a manner to adjust the operating parameters of the combine harvester 10, in particular to automatically or manually set the propelling rate of the combine harvester 10 and/or to adjust the speed of the blower 40 and the sieve opening width of the upper sieve 44, the lower sieve 46, or both.

The losses calibrated in this way can also be used to create loss maps in which the losses are georeferenced as a function of the location. In addition, the camera 114 and the associated image processing can be used to determine other properties of the grains, such as fractions of broken grains or the dimensions and thus the volume of the individual grains, which, in conjunction with the signals from the force sensors 110, can also be used to determine the thousand-grain mass. These values can also be used to set the operating parameters of the combine harvester 10 and/or be mapped in a georeferenced manner.

It should also be noted that the sampling device 66 can be designed in any other way. For example, the sample could be removed from the material flow through a swing-open door or flap, which could be located, for example, in one or both of the conveyor floors 50, 58 or on a lateral surface or at the top of a channel through which the material flow flows, cf. DE 102 30 475 A1 (the contents of which are incorporated herein by reference), or the sample could be extracted by suction from the material flow.

It would also be conceivable to operate the sensor arrangement 64 continuously. For this purpose, two or more sensor assemblies 64 could be distributed over the width of the material flow discharged from the upper sieve 44, and two or more sensor arrangement 64a could be distributed over the width of the crop residue stream downstream of the threshing and separating device 22. The sensor arrangement 64 and sensor arrangement 64a can be operated continuously to continuously sense the lost grains. The impact plate sensors 118, 120 could be omitted in this case or used to check the signals of the sensor arrangement(s) 64 for plausibility.

In addition, the separation device 68 shown in the figures, which is designed as a centrifugal separator or a cyclone separator, can be replaced by any other embodiment, such as an air-flowed sieving device which may be similar to the upper or lower sieve 44, 46, or a so-called zigzag classifier (see DE 42 22 364 A1, the contents of which are incorporated by reference).

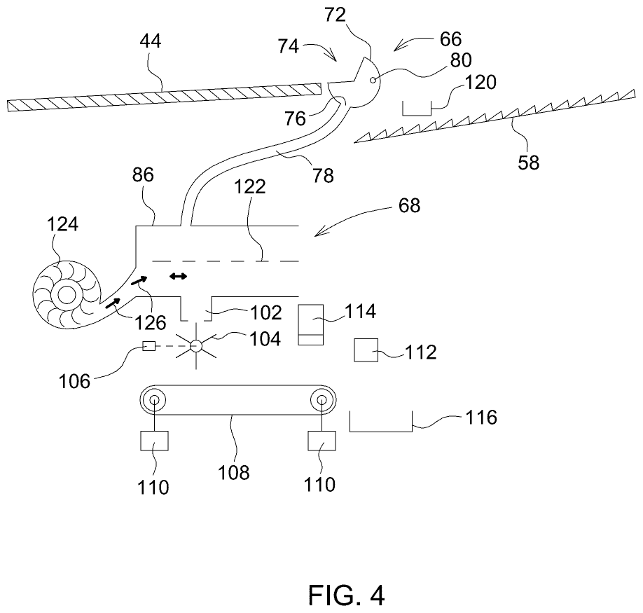

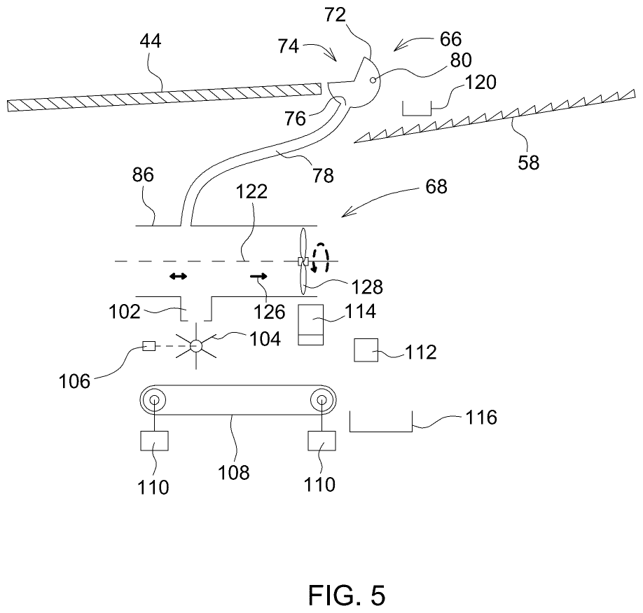

FIG. 4 accordingly shows a further embodiment in which the separation device 68 includes a sieve 122 pressurized by a blower 124 from below with an air flow 126. The sieve 122 moves back and forth and, if desired, also up and down, in order to effect the separation of grains and impurities. In the embodiment according to FIG. 5, which otherwise corresponds to the one of FIG. 4, the blower is replaced by a fan 128, which, similar to an extractor of a sugar cane harvester, generates a vacuum and produces the air flow 126. The opening size of the sieve 122 can be adjustable in the embodiments according to FIGS. 4 and 5 and, thus, adaptable to the dimensions of the grains, e.g., by adjusting lamellae (analogous to the screens 44) or by adjusting two perforated screens against each other (see DE 192 45 445 A1, the disclosure of which is included by reference).

What is claimed is:

1. A sensor arrangement configured to detect grains in a material stream containing grains and non-grain components in a combine harvester, the sensor arrangement comprising:
a sampling device configured to collect a sample from the material stream;
a separation device configured to separate the sample into grains and non-grain constituents; and
a sensor system configured to sense the grains separated from the non-grain constituents.

2. The sensor arrangement of claim 1, wherein the sampling device is configured to collect the sample downstream of a rear end of an upper sieve; downstream of a rear end of a lower sieve; between a threshing device and a cleaning device; between a separation device and a cleaning device; downstream of a crop residue outlet of the threshing, device; or downstream of a crop residue outlet of the separation device.

3. The sensor arrangement of claim 1, wherein the sampling device is movable over a width of the material flow.

4. The sensor arrangement of claim 1, wherein the separation device includes a centrifugal separator, a cyclone separator, a sieving device, or zig-zag classifier.

5. The sensor arrangement of claim 1, wherein the sensor system comprises a camera with image processing configured to detect the grains or a force sensor configured to detect a weight of the grains separated from the non-grain constituents.

6. Sensor arrangement, wherein the separation device comprises:
a collection chamber configured to collect grains separated from the non-grain constituents; and
a dispensing mechanism configured to feed the grains from the collection chamber to the sensor system.

7. A combine harvester comprising the sensor arrangement of claim 1.

8. The combine harvester of claim 7, further comprising a control device configured to control one or more operating parameters of the combine harvester based on one or more signals of the sensor system.

9. The combine harvester of claim 8, wherein the control device is connected to one or more impact plate sensors configured to detect lost grains and configured to fuse the signals of the one or more impact plate sensors with the signals of the sensor assembly.

10. A method for sensing grains in a material stream containing grains and non-grain components in a combine harvester, the method comprising:
collecting a sample from the material stream with a sampling device;
separating, with a separation device, the sample into grains and non-grain constituents; and
detecting, with a sensor system, the grains separated from the non-grain constituents.
